(19) United States
(12) Patent Application Publication
(10) Pub. No.: US 2022/0029447 A1
(43) Pub. Date: Jan. 27, 2022

(54) POWER CONTROL SYSTEM

(71) Applicant: AISIN CORPORATION, Kariya (JP)

(72) Inventors: Taiki NAGAO, Kariya (JP); Atsushi SUGIURA, Kariya (JP); Hiroshi KAMIYA, Kariya (JP); Toshiyuki SATO, Kariya (JP)

(73) Assignee: AISIN CORPORATION, Kariya (JP)

(21) Appl. No.: 17/305,874

(22) Filed: Jul. 16, 2021

(51) Int. Cl. H02J 7/02; H02J 3/32; H02J 3/38; H05B 3/00; F24D 3/14

(52) U.S. Cl. CPC H02J 7/02; H02J 3/32; H02J 3/38; F24D 2200/26; F24D 3/14; H02J 2300/30; H05B 3/0014

(57) ABSTRACT

A power control system includes: a power generation device; and a storage battery that receives and stores power from a commercial power system or the power generation device. When power supply from the commercial power system is stopped, constant power is output from the power generation device, and the power is supplied to a first load, and surplus power thereof is supplied to the storage battery, and when a power storage rate of the storage battery is equal to or greater than a predetermined value, the surplus power is supplied to and consumed by a second load.

### CROSS REFERENCE TO RELATED APPLICATIONS

This application is based on and claims priority under 35 U.S.C. §119 to Japanese Patent Application 2020-124293, filed on Jul. 21, 2020, the entire content of which is incorporated herein by reference.

### TECHNICAL FIELD

This disclosure relates to a power control system. In particular, this disclosure relates to a power control system that controls a route through which power output by a power generation device installed in a consumer (general house) is supplied to a load, when power supply from a commercial power system to the consumer is stopped (during a power failure).

### BACKGROUND DISCUSSION

For example, JP 2014-212655A discloses a power control system. This power control system includes a power generation device (private power generation device) and a storage battery. When power can be supplied from a commercial power system to a consumer (during a non-power failure), the power is supplied to the load (for example, lighting or television) from any one or both of the commercial power system and the power generation device (linkage operation mode). On the other hand, when power supply from the commercial power system is stopped (during a power failure), the power output from the power generation device is supplied to the load (autonomous operation mode). In the linkage operation mode and the autonomous operation mode, charging and discharging a storage battery are controlled in accordance with a power storage rate (current storage amount (remaining amount) with respect to a maximum storage amount) of the storage battery.

A power control system in the related art has a load tracking mode and a rated mode, as operation modes of a power generation device. The load tracking mode is an operation mode in which a power generation amount of the power generation device is adjusted, based on power consumption of a load. The rated mode is an operation mode in which the power generation device outputs constant power (rated power) regardless of a magnitude of the power consumption of the load. Power supply from a commercial power system is stopped, the operation mode of the power generation device is set to the rated mode, and the power consumption of the load is smaller than rated power. When a storage battery is in a fully charged state, power output from the power generation device is not consumed so much, and surplus power is excessive. Consequently, it is not preferable to adopt the power control system in the related art.

A need thus exists for a power control system which is not susceptible to the drawback mentioned above.

### SUMMARY

A power control system according to an aspect of this disclosure includes a power generation device and a storage battery that receives and stores power from a commercial power system or the power generation device. When power supply from the commercial power system is stopped, constant power is output from the power generation device, and the power is supplied to a first load, and surplus power thereof is supplied to the storage battery. When a power storage rate of the storage battery is equal to or greater than a predetermined value, the surplus power is supplied to and consumed by a second load.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram of a power control system according to an embodiment of this disclosure;

FIGS. 2A and 2B are block diagrams illustrating an operation of an electric circuit switching device in FIG. 1;

FIG. 3 is a block diagram illustrating a power supply route in a linkage operation mode;

FIG. 4 is a block diagram illustrating a power supply route in an autonomous operation mode;

FIG. 5 is a block diagram of a power control system according to a modification example of this disclosure; and

FIGS. 6A and 6B are block diagrams illustrating an operation of an electric circuit switching device in FIG. 5.

### DETAILED DESCRIPTION

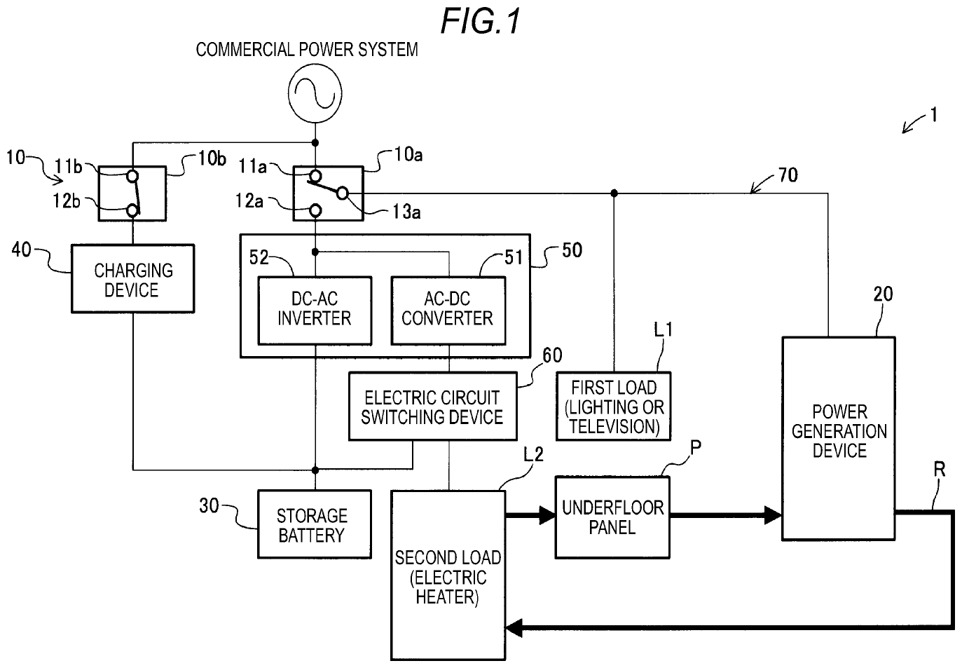

Hereinafter, a power control system 1 according to an embodiment of this disclosure will be described (refer to FIG. 1). The power control system 1 is applicable to a consumer (for example, a general house) as in the power control system in the related art.

The power control system 1 includes a mode switch 10, a power generation device 20, a storage battery 30, a charging device 40, a power conversion device 50, an electric circuit switching device 60, and an electric wire 70 serving as a power supply passage for connecting the devices. As illustrated in the drawing, the power control system 1 is connected to a commercial power system. In addition, a first load L1 and a second load L2 are connected to the power control system 1.

The mode switch 10 is used to switch between a linkage operation mode and an autonomous operation mode (to switch between a state where the power control system 1 is connected to the commercial power system and a state where the power control system 1 is disconnected from the commercial power system). The mode switch 10 includes a switch 10a and a switch 10b. In the present embodiment, as the switch 10a, a well-known double-throw type (c-type) switch having a first contact 11a, a second contact 12a, and a third contact 13a is adopted. That is, it is possible to switch between a state where the first contact 11a and the third contact 13a are electrically connected to each other and the second contact 12a is disconnected from other contacts, and a state where the second contact 12a and the third contact 13a are electrically connected to each other and the first contact 11a is disconnected from other contacts. In addition, in the present embodiment, as the switch 10b, a well-known single-cut type (b-type) switch having a first contact 11b and a second contact 12b is adopted. That is, it is possible to switch between a state where the first contact 11b and the second contact 12b are electrically connected to each other, and a state where the first contact 11b and the second contact 12b are disconnected from each other. In the present embodiment, the switches 10a and 10b are manually operated.

For example, the power generation device 20 includes a gas engine-driven power generator. That is, the power generation device 20 includes a gas engine that burns a gas fuel and drives a piston to output a rotational driving force, and a power generator that converts the rotational driving force of the gas engine into AC power.

Furthermore, the power generation device 20 is connected to a circulation path R (pipe connected in an annular shape) of a circulating fluid (hot water) of a hot water type floor heater. The power generation device 20 includes a heater (first heater of this disclosure) and a circulation device (pump), in which the circulating fluid cooled by releasing heat from an underfloor panel P is heated by using exhaust heat of the gas engine, and the heated circulating fluid is fed again to the underfloor panel P.

The power generation device 20 includes a controller (computer device) that controls the gas engine, the power generator, the heater, and the circulation device.

A power output terminal of the power generation device 20 is connected to the third contact 13a of the switch 10a. The first load L1 is connected to the midpoint between the power output terminal and the third contact 13a of the switch 10a.

For example, the first load L1 is a home appliance (lighting or television), and power consumption of the first load L1 as a whole varies depending on a usage status thereof.

The storage battery 30 can convert electrical energy (DC power (for example, “48 V DC”)) into chemical energy, and can store the chemical energy. In addition, the storage battery 30 converts the stored chemical energy into electrical energy (DC power (for example, “48V DC”)), and outputs (discharges) the electrical energy. In the present embodiment, a well-known lead storage battery is adopted as the storage battery 30. A battery type of the storage battery 30 is not limited to the lead storage battery, and other types (for example, a lithium-ion battery) may be adopted.

The charging device 40 is connected to a commercial power system and the storage battery 30 via the switch 10b. That is, the first contact 11 b of the switch 10b is connected to the commercial power system. An input terminal of the charging device 40 is connected to the second contact 12b, and an output terminal of the charging device 40 is connected to a terminal of the storage battery 30. The charging device 40 converts AC power (for example, “100 V AC”, “117 V AC”, or “230 V AC”) which is supply power of the commercial power system into DC power (“48 V DC”) which is charging power of the storage battery 30, and charges the storage battery 30 with the DC power. The charging device 40 monitors a power storage rate of the storage battery 30, based on a terminal voltage of the storage battery 30, and stops charging when the power storage rate increases and reaches a predetermined value (for example, 100%). That is, the charging device 40 has a function of preventing overcharging of the storage battery 30. When the storage battery 30 is discharged (power is consumed) and the power storage rate of the storage battery 30 decreases to some extent (for example, when the power storage rate falls below 30%), the charging device 40 restarts charging the storage battery 30.

The power conversion device 50 includes a well-known AC-DC converter 51 and a DC-AC inverter 52. The power conversion device 50 is operated in the autonomous operation mode, and is not operated in the linkage operation mode.

The AC-DC converter 51 includes a switching device and a transformer to convert the AC power into the DC power. An input terminal (AC power input terminal) of the AC-DC converter 51 is connected to the second contact 12a of the switch 10a, and an output terminal (DC power output terminal) of the AC-DC converter 51 is connected to the electric circuit switching device 60 (to be described later). The AC-DC converter 51 converts the supply power of the commercial power system into the DC power, and outputs the DC power in the autonomous operation mode. A voltage of the DC power is equivalent to a voltage of the charging power of the storage battery 30 (“48V DC”).

The DC-AC inverter 52 includes a switching device and a transformer to convert the DC power into the AC power. An input terminal (DC power input terminal) of the DC-AC inverter 52 is connected to a terminal (connection point the same as a connection point of the output terminal of the charging device 40) of the storage battery 30, and an output terminal (AC power output terminal) of the DC-AC inverter 52 is connected to the second contact 12a of the switch 10a. In the autonomous operation mode, the DC-AC inverter 52 converts the DC power (“48V DC”) which is output power of the storage battery 30, into the supply power of the commercial power system, and outputs the DC power. A voltage of the AC power is equivalent to a voltage of the power of the commercial power system (for example, “100V AC”, “117V AC”, or “230V AC”).

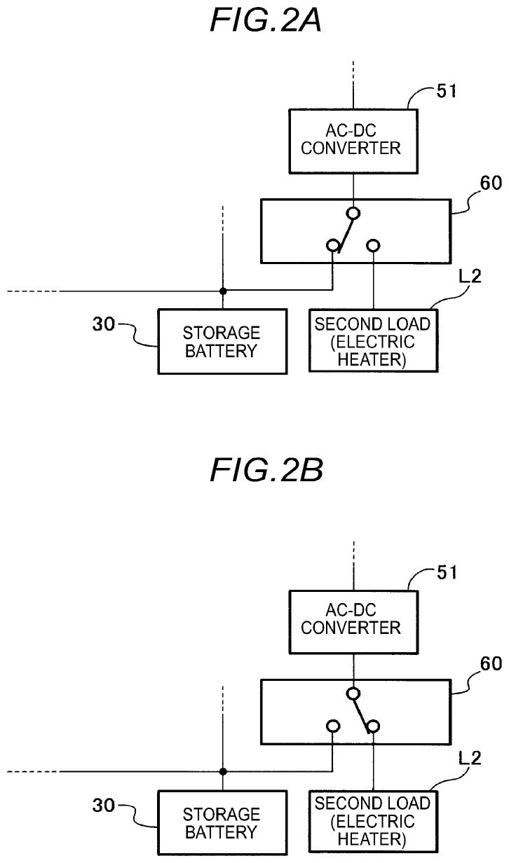

The electric circuit switching device 60 is provided between the AC-DC converter 51, the storage battery 30, and the second load L2 (to be described later). For example, the electric circuit switching device 60 includes a c-contact type relay (DC power relay). The electric circuit switching device 60 switches between electric circuits (connection states between the AC-DC converter 51, the storage battery 30, and the second load L2) of the power (current) between the storage battery 30 and the second load L2 in accordance with a power storage rate (terminal voltage) of the power conversion device 50 and the storage battery 30. Specifically, a first state (FIG. 2A) and a second state (FIG. 2B) which are described below are switched. The first state is a state where the AC-DC converter 51 and the storage battery 30 are connected to each other, and the second load L2 is disconnected from the AC-DC converter 51 and the storage battery 30. The second state is a state where the AC-DC converter 51 and the second load L2 are connected to each other, and the storage battery 30 is disconnected from the AC-DC converter 51 and the second load L2. The storage battery 30 and the second load L2 are not directly connected to each other. When the storage battery 30 is charged in the first state and the power storage rate increases and reaches a predetermined value (for example, 100%), the electric circuit switching device 60 switches the first state to the second state. When the storage battery 30 is discharged in the second state and the power storage rate of the storage battery 30 decreases and falls below a predetermined value (for example, 30%), the electric circuit switching device 60 switches the second state to the first state.

The second load L2 is an electric heater (second heater of this disclosure) provided in an intermediate portion of the circulation path R of the circulating fluid (hot water) of the above-described hot water type floor heater. That is, the second load L2 is configured to include an electric resistor that generates heat when a direct current flows.

Next, an operation and a power supply route of each device in the linkage operation mode and the autonomous operation mode of the power control system 1 configured as described above will be described.

### Linkage Operation Mode

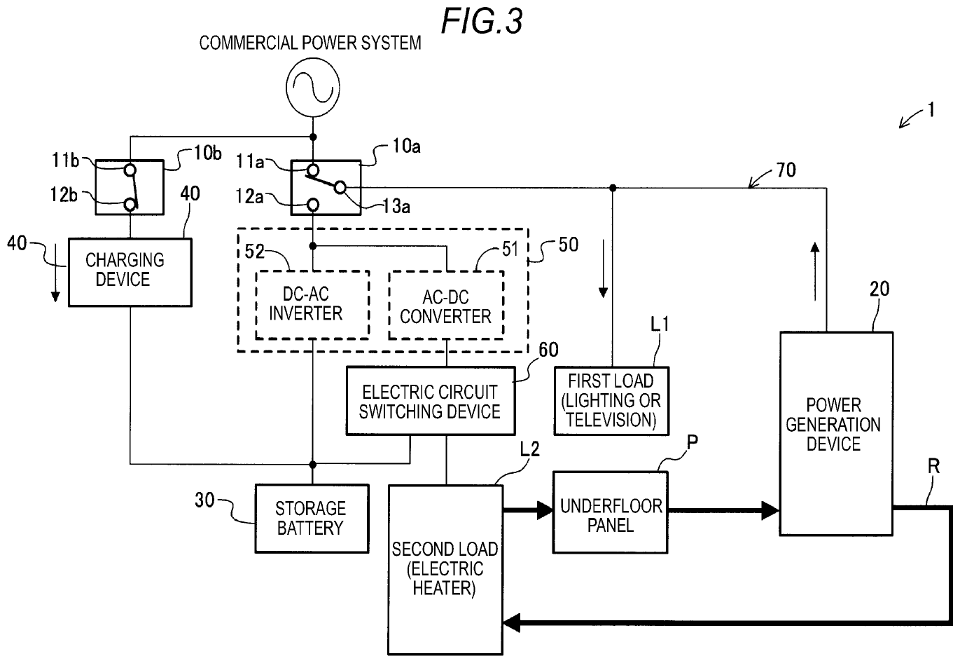

In a normal state (non-power failure state), the first contact 11a and the third contact 13a of the switch 10a are set to be in an electrically connected state, and the first contact 11b and the second contact 12b of the switch 10b are set to be in an electrically connected state (refer to FIG. 3). In the linkage operation mode, the power conversion device 50 is stopped. That is, no power is output from the output terminal of the AC-DC converter 51 and the DC-AC inverter 52. In addition, in the linkage operation mode, the power generation device 20 is operated to output constant power. The output power is rated power (for example, 1.5 kW). When the power consumption of the first load L1 is larger than the rated power of the power generation device 20, a shortage thereof is supplied to the first load L1 from the commercial power system. In addition, the power of the commercial power system is supplied to the storage battery 30 via the charging device 40, thereby charging the storage battery 30. On the other hand, when the power consumption of the first load L1 is smaller than the rated power of the power generation device 20, surplus power thereof is supplied to the storage battery 30 via the charging device 40, thereby charging the storage battery 30. As described above, when the power storage rate of the storage battery 30 is relatively high, charging the storage battery 30 is stopped. In this case, the surplus power is caused to reversely flow (is sold) to the commercial power system. In addition, the circulating fluid cooled by releasing heat from the underfloor panel P returns to the power generation device 20, is heated by using the exhaust heat of the gas engine in the power generation device 20, and is fed to the underfloor panel P again. Here, as described above, the power conversion device 50 is stopped in the linkage operation mode. Accordingly, the power of the commercial power system and the power generation device 20 is not converted by the AC-DC converter 51. In addition, there is no electric circuit from the storage battery 30 to the second load L2. Accordingly, no power is supplied to the second load L2. Therefore, the refrigerant of the hot water type floor heater is heated by the power generation device 20, and is not heated by the electric heater configuring the second load L2.

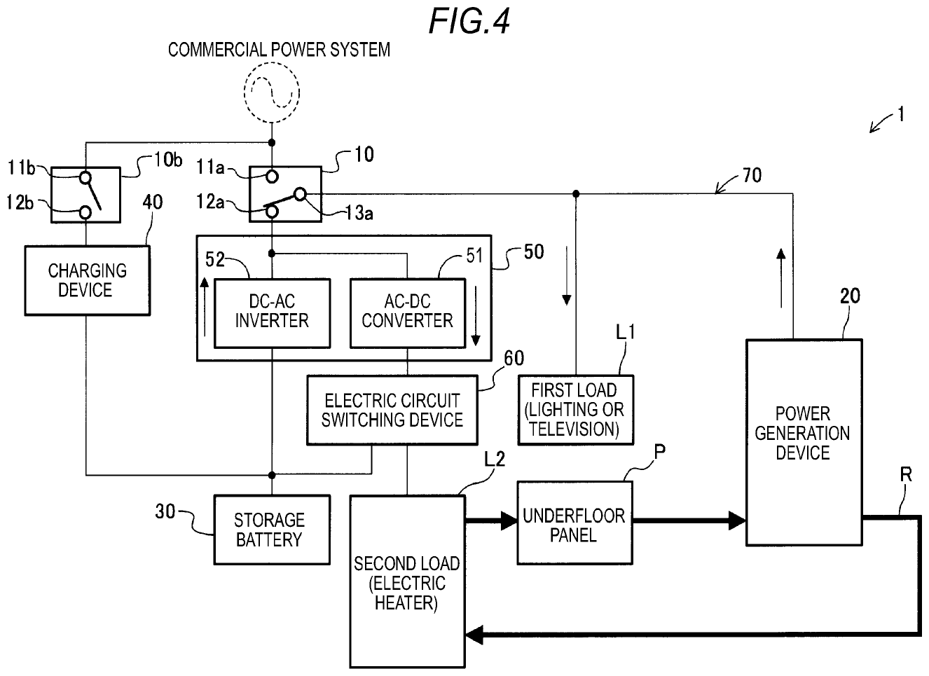

In the linkage operation mode, the power generation device 20 is configured to be temporarily stopped when the power supply from the commercial power system is stopped (power failure). Therefore, the power is not supplied to the first load L1. In this case, through a manual operation, the second contact 12a and the third contact 13a of the switch 10a are set to be in an electrically connected state, and the first contact 11b and the second contact 12b of the switch 10b are set to be in a disconnected state. In this manner, the power control system 1 shifts the linkage operation mode to the autonomous operation mode (refer to FIG. 4) described below. The switch 10a and the switch 10b may be separately and manually operated. Alternatively, a configuration may be adopted as follows. When one switch is operated, a state of the other switch may be switched in conjunction with the operation.

### Autonomous Operation Mode

When the linkage operation mode is shifted to the autonomous operation mode, first, the power stored so far in the storage battery 30 is supplied to a controller of the power generation device 20 via the DC-AC inverter 52. In this manner, the power generation device 20 restarts, restarts power generation, and outputs the constant power. The output power is rated power, and the output power is supplied to the first load L1. In the autonomous operation mode, it is assumed in principle that the power consumption of the first load L1 is minimized to be equal to or lower than the rated power of the power generation device 20. The power (surplus power) obtained by subtracting the power consumed by the first load L1 from the output power of the power generation device 20 is converted into the DC power by the AC-DC converter 51. When the electric circuit switching device 60 is in the first state (that is, when the remaining amount of the storage battery 30 is relatively low), the output power of the AC-DC converter 51 is supplied to the storage battery 30 instead of the second load L2. In this manner, the storage battery 30 is charged. On the other hand, when the electric circuit switching device 60 is in the second state (that is, when the remaining amount of the storage battery 30 is relatively large), the output power of the AC-DC converter 51 is supplied to the second load L2 instead of the storage battery 30. In this manner, the circulating fluid of the hot water type floor heater is heated by the power generation device 20, is further heated by the electric heater configuring the second load L2, and is supplied to the underfloor panel P.

As described above, in the autonomous operation mode, it is assumed that the power consumption of the first load L1 is minimized to be equal to or lower than the rated power of the power generation device 20. However, even when the power consumption of the first load L1 slightly exceeds the rated power of the power generation device 20, the power is supplied to the first load L1 from the storage battery 30 via the DC-AC inverter 52, and the operation of the first load L1 can temporarily be continued. In addition, in this case, when the electric circuit switching device 60 is in the second state, the power of the storage battery 30 is also supplied to the second load L2 via the DC-AC inverter 52, the AC-DC converter 51 and the electric circuit switching device 60. In this manner, when the power storage rate (remaining amount) of the storage battery 30 decreases and falls below a predetermined value (for example, 30%), the electric circuit switching device 60 switches the second state to the first state. In this state, when the power consumption of the first load L1 decreases and the surplus power is generated during the autonomous operation mode, the surplus power is supplied to the storage battery 30 via the AC-DC converter 51 and the electric circuit switching device 60, and the storage battery 30 is charged. In addition, when the commercial power system is restored, the switch 10a and the switch 10b are manually operated again, and the autonomous operation mode is shifted to the linkage operation mode. In that case, the power of the commercial power system is supplied to the storage battery 30 via the charging device 40, and the storage battery 30 is charged.

In the autonomous operation mode of the power control system 1 configured as described above, the power (rated power) output from the power generation device 20 is not consumed so much by the first load L1. When the power is not used as charging power of the storage battery 30, the surplus power is consumed by the second load L2. Therefore, it is possible to prevent the surplus power from being excessive.

In addition, as described above, in the power control system 1, the power generation device 20 outputs the rated power in both the linkage operation mode and the autonomous operation mode (rated mode). That is, the power generation device 20 does not include a system (load tracking mode) that adjusts the output power in response to the power consumption of the first load L1. Therefore, a configuration of the power control system 1 is simple, and component costs or maintenance cost can be reduced. However, the power control system 1 may be configured to include a load tracking mode in addition to the above-described rated mode so that both modes can be switched therebetween.

In addition, embodiments of this disclosure are not limited to the above-described embodiment, and various modifications can be made as long as the embodiments do not depart from the object of this disclosure.

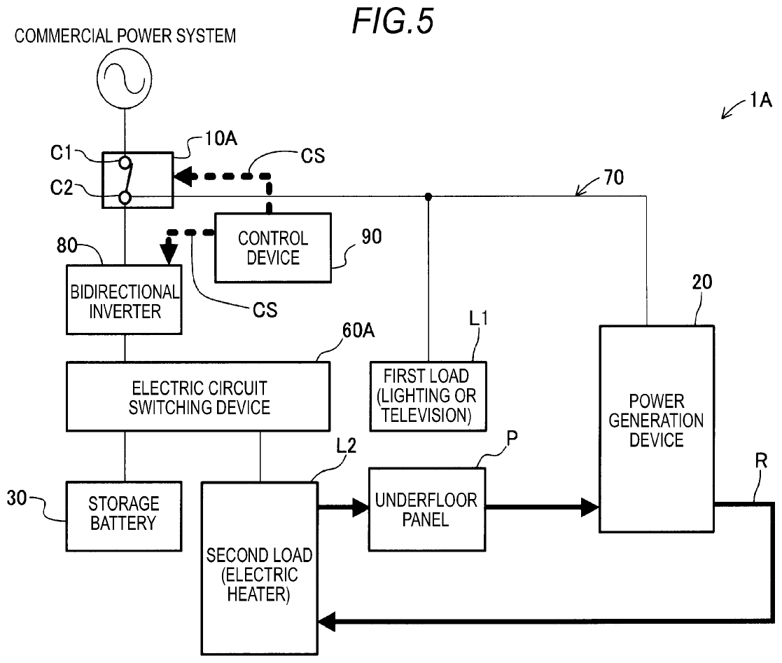

For example, in the above-described embodiment, in the linkage operation mode, the storage battery 30 is only charged by using the power of the commercial power system, and is not used as a power source of the first load L1 (and/or the second load L2). That is, the storage battery 30 is mainly used as a power source for restarting the power generation device 20, when the linkage operation mode is shifted to the autonomous operation mode. In addition, the storage battery 30 may be used as a power source for the first load L1 in the linkage operation mode. In order to realize this function, for example, a configuration such as the power control system 1A illustrated in FIG. 5 may be adopted. In an example in the drawing, a mode switch 10A is used instead of the mode switch 10 of the above-described embodiment. In addition, a bidirectional inverter 80 is used instead of the charging device 40 and the power conversion device 50 of the above-described embodiment. In addition, an electric circuit switching device 60A is used instead of the electric circuit switching device 60 of the above-described embodiment. In addition, there is provided a control device 90 for controlling the devices by transmitting a control signal CS to the mode switch 10A and the bidirectional inverter 80.

As in the above-described embodiment, the mode switch 10A is provided to switch between the operation modes (to switch between a state where the power control system 1A is connected to the commercial power system and the state where the power control system 1A is disconnected from the commercial power system). As illustrated in the drawing, the mode switch 10A has a first contact C1 and a second contact C2. A switching state of the mode switch 10A is controlled by the control device 90 as described below. However, the mode switch 10A may have a function of detecting a power supply state from the commercial power system, and may be configured to switch between the switching states in accordance with a detection result thereof.

The bidirectional inverter 80 is configured to be capable of switching between a state of functioning as the AC-DC converter and a state of functioning as the DC-AC inverter. The functions are switched therebetween by the control device 90.

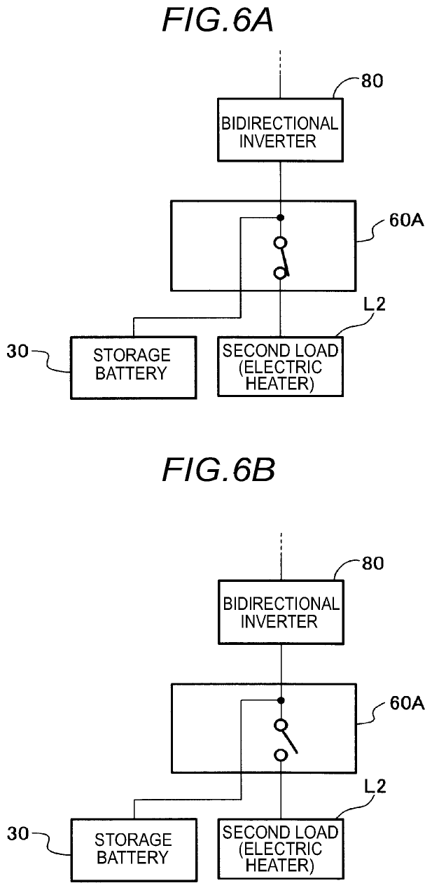

The electric circuit switching device 60A is configured to be capable of switching between the first state (FIG. 6A) and the second state (FIG. 6B) in accordance with a charging rate (terminal voltage) of the storage battery 30. The first state is a state where the bidirectional inverter 80 and the second load L2 are connected to each other, and the second state is a state where the bidirectional inverter 80 and the second load L2 are disconnected from each other. The electric circuit switching device 60A is in the first state when the power storage rate of the storage battery 30 is approximately 100% (when the terminal voltage is approximately maximum), and otherwise, the electric circuit switching device 60A is in the second state. In both the first state and the second state, the bidirectional inverter 80 and the storage battery 30 are connected to each other. However, instead of a configuration in which the electric circuit switching device 60A detects the power storage rate of the storage battery 30 to switch between the switching states, the switching states of the electric circuit switching device 60A may be switched therebetween by the control device 90.

### Linkage Operation Mode

In the normal state (non-power failure state), the first contact C1 and the second contact C2 of the mode switch 10A are set to be in an electrically connected state. When the power consumption of the first load L1 is larger than the rated power of the power generation device 20 and the power storage rate of the storage battery 30 is relatively high (when the remaining amount is relatively large), the control device 90 causes the bidirectional inverter 80 to function as the DC-AC inverter. In this manner, the power of the storage battery 30 is supplied to the first load L1. As described above, the electric circuit switching device 60A is in the first state, when the power storage rate of the storage battery 30 is approximately 100% and the terminal voltage has approximately the maximum value. However, in a state where the storage battery 30 is discharged, the terminal voltage drops to some extent. Accordingly, the electric circuit switching device 60A is in the second state. Therefore, the power is not supplied to the second load L2. In addition, when the power storage rate of the storage battery 30 is relatively low (when the remaining amount is relatively small), the control device 90 causes the bidirectional inverter 80 to function as the AC-DC converter. In this manner, the surplus power of the commercial power system and/or the power generation device 20 is supplied to the storage battery 30, and the storage battery 30 is charged. In addition, when the power storage rate of the storage battery 30 is approximately 100% and the power consumption of the first load L1 is smaller than the rated power of the power generation device 20, the charging state of the storage battery 30 or the electric circuit switching device 60A is controlled by the control device 90 so that the electric circuit switching device 60A is in the second state. The surplus power of the power generation device 20 is caused to reversely flow (sold) to the commercial power system.

### Autonomous Operation Mode

When the power supply from the commercial power system is stopped, the control device 90 sets the mode switch 10A to be in a state where the first contact C1 and the second contact C2 are disconnected from each other. First, the control device 90 causes the bidirectional inverter 80 to function as the DC-AC inverter. In this manner, the power stored so far in the storage battery 30 is supplied to the controller of the power generation device 20, and the power generation device 20 is restarted.

After the power generation device 20 is restarted, the control device 90 switches between the functions of the bidirectional inverter 80 in accordance with the power storage rate of the storage battery 30. For example, when the power storage rate of the storage battery 30 decreases and falls below 30%, the control device 90 causes the bidirectional inverter 80 to function as the AC-DC converter. In this manner, the surplus power (power obtained by subtracting the power consumption of the first load L1 from the output power of the power generation device 20) is supplied to the storage battery 30, and the storage battery 30 is charged. When the power storage rate of the storage battery 30 increases and reaches 100%, the electric circuit switching device 60A switches the first state to the second state. In this manner, the surplus power is supplied to the second load L2, and is consumed by the second load L2.

When the bidirectional inverter 80 functions as the DC-AC inverter in the autonomous operation mode, the power of the storage battery 30 can be supplied to the first load L1.

In addition, in the above-described embodiment, the power generation device 20 includes a gas engine-driven power generator. However, another method may be adopted as the power generation method. For example, a fuel cell type power generator may be adopted. In addition, in the above-described embodiment, the exhaust heat of the gas engine is used as a heat source for heating the circulating fluid of the hot water type floor heater. Alternatively, for example, the exhaust heat of the gas engine may be used as a heat source for a panel (wall) heater, a road heater for melting snow, or a central heating system. In addition, the second load L2 is not limited to the above-described embodiment, and may be any device as long as the device can consume the surplus power. For example, a spare storage battery may be used as the second load L2.

In addition, the power control systems 1 and 1A may include a photovoltaic power generation device in addition to the above-described configuration. For example, the photovoltaic power generation device is connected to the bidirectional inverter 80 of the power control system 1A. In this case, the control device 90 may control the bidirectional inverter 80 in accordance with the power consumption of the first load L1, the power storage rate of the storage battery 30, and the output power of the photovoltaic power generation device.

A power control system according to an aspect of this disclosure includes a power generation device and a storage battery that receives and stores power from a commercial power system or the power generation device. When power supply from the commercial power system is stopped, constant power is output from the power generation device, and the power is supplied to a first load, and surplus power thereof is supplied to the storage battery. When a power storage rate of the storage battery is equal to or greater than a predetermined value, the surplus power is supplied to and consumed by a second load.

In the power control system according to one embodiment of this disclosure, the power generation device may include a first heater that heats a refrigerant by using heat generated by a power generation. The second load may include a second heater that heats the refrigerant.

In the power control system according to another embodiment of this disclosure, when a power consumption of the first load is larger than the power output from the power generation device, the power may be supplied to the first load from the storage battery.

In the power control system according to the aspect of this disclosure, when the power output from the power generation device (rated power) is not consumed so much by the first load and is not used as charging power of the storage battery, the surplus power is consumed by the second load. Therefore, it is possible to prevent the surplus power from being excessive.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A power control system comprising:
a power generation device; and
a storage battery that receives and stores power from a commercial power system or the power generation device, wherein
when power supply from the commercial power system is stopped, constant power is output from the power generation device, and the power is supplied to a first load, and surplus power thereof is supplied to the storage battery, and
when a power storage rate of the storage battery is equal to or greater than a predetermined value, the surplus power is supplied to and consumed by a second load.

2. The power control system according to claim 1, wherein
the power generation device includes a first heater that heats a refrigerant by using heat generated by a power generation, and
the second load includes a second heater that heats the refrigerant.

3. The power control system according to claim 1, wherein
when a power consumption of the first load is larger than the power output from the power generation device, the power is supplied to the first load from the storage battery.
